(19) United States
(12) Patent Application Publication
(10) Pub. No.: US 2012/0065798 A1
(43) Pub. Date: Mar. 15, 2012

(54) DEMAND RESPONSE OF DEVICES WHEN DIFFERENT DEVICES ARE BEING SIGNALED TO SHED LOAD

(75) Inventors: MICHAEL F. FINCH, Louisville, KY (US); Jeff Donald Drake, Louisville, KY (US)

(73) Assignee: General Electric Company

(21) Appl. No.: 12/980,452

(22) Filed: Dec. 29, 2010

(51) Int. Cl. G06F 1/26

(52) U.S. Cl. 700/295

(57) ABSTRACT

A household energy management system and method for managing multiple appliances is provided comprising: a central controller for managing power consumption of multiple appliances within a household, each appliance including an appliance controller; and, a communication network connecting the central controller to one or more of a utility meter and/or a demand server. The central controller maintains in a memory the managing of power consumption of the multiple appliances. The central controller instructs one or more appliances to shed load demand in response to inputs from the utility meter or demand server. Each appliance controller is configured to respond to shed load instructions from the central controller directed to it or directed to at least one other associated appliance by changing its load demand.

### BACKGROUND

Many power providers are currently experiencing a shortage of electric generating capacity due to increasing consumer demand for electricity. More specifically, generating plants are often unable to meet peak power demands resulting from electricity demanded by many consumers at the same time.

In order to reduce high peak power demand, many power providers have instituted time of use metering and rates which include higher rates for energy usage during on-peak times and lower rates for energy usage during off-peak times. As a result, consumers are provided with an incentive to use electricity at off-peak times rather than on-peak times.

Presently, to take advantage of the lower cost of electricity during off-peak times, a user must manually operate appliances or other electronic devices during the off-peak times. This is undesirable because a consumer may not always be present in the home, or awake, to operate the appliance during off-peak hours. This is also undesirable because the consumer is required to manually track the current time to determine what hours are off-peak and on-peak. Therefore, there is a need to provide a system that facilitates operating appliances during off-peak hours in order to reduce consumer's electric bills and to reduce the load on generating plants during on-peak hours.

### SUMMARY

In one aspect of the invention, a household energy management system and method for managing multiple appliances is provided comprising: a central controller for managing power consumption of multiple appliances within a household, each appliance including an appliance controller; a communication network connecting the central controller to one or more of a utility meter and/or a demand server; the central controller maintains in a memory the managing of power consumption of the multiple appliances; and, the central controller instructs one or more appliances to shed load demand in response to inputs from the utility meter or demand server, and wherein each appliance controller is configured to respond to shed load instructions from the central controller directed to it or directed to at least one other associated appliance by changing its load demand.

In yet another aspect, the invention provides a household energy management method for managing multiple household appliances, comprising: establishing a pre-determined association of one appliance to at least another appliance wherein a load change to the one appliance is associated to at least one load change to the at least another appliance; and, wherein shedding load of the one appliance initiates the load changing of the at least another appliance.

In yet still another aspect, a household energy management system and method for managing multiple appliances is provided comprising: a central controller for controlling the operation of multiple appliances in a normal mode and a modified mode; each appliance having an appliance controller configured to be associated with at least one other appliance, the central controller being configured to establish a hierarchy and manner for disabling, suspending, or otherwise changing one or more functions of one or more of the multiple appliances, when in the modified mode and, wherein reducing the load of one appliance in the modified mode initiates a change in the load of at least one associated appliance.

In yet a further aspect, a household energy management system and method for managing multiple appliances is provided, comprising: a controller for managing power consumption of multiple appliances within a household including establishing a hierarchy of an order and manner for the controller to disable, suspend, reduce, or increase one or more functions of at least one of the appliances; a communication network connecting the controller to one or more of the utility meter and/or the demand server; each appliance including an appliance controller configured to maintain in a memory an association to at least another appliance; and,

wherein the controller is operative to direct a shed load command to one or more appliance controllers, and wherein the one or more appliance controllers are operative in response to shed load and the appliance controllers for the appliances associated with the one or more appliances are operative in response to change load.

### BRIEF DESCRIPTION OF THE DRAWINGS

FIG. 1 is a flow chart of a prior art load shed command response;

FIG. 2 is a first exemplary flow chart of a load shed command response according to the present disclosure;

FIG. 3 is a second exemplary flow chart of a load shed command response according to the present disclosure;

FIG. 4 is a third exemplary flow chart of a load shed command response according to the present disclosure; and,

FIG. 5 is an exemplary load shed command response flow chart for a household energy management system according to the present disclosure.

### DETAILED DESCRIPTION

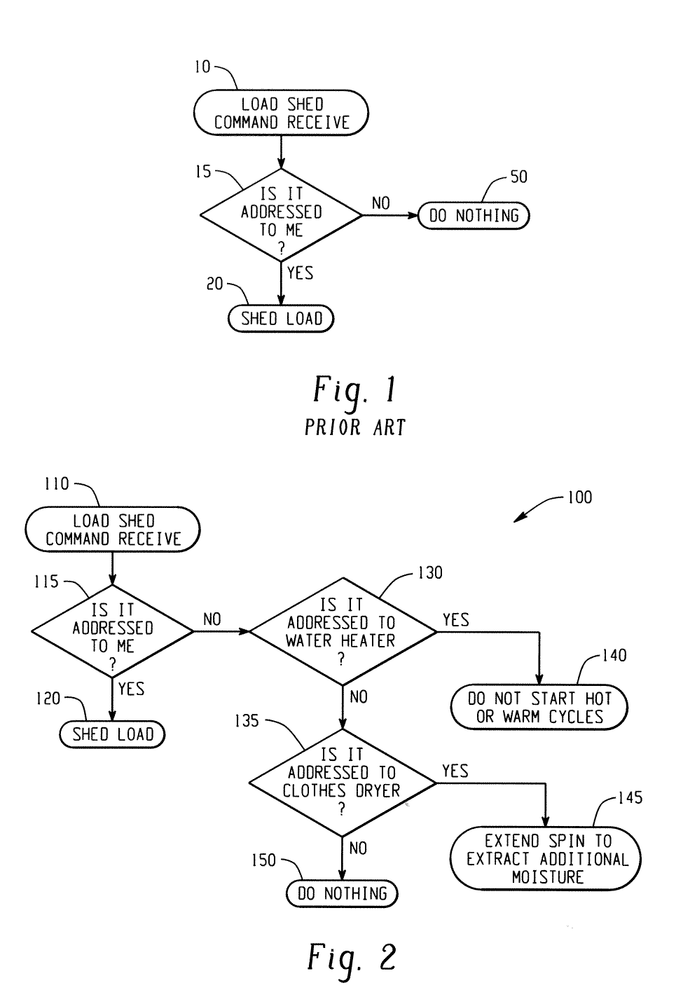

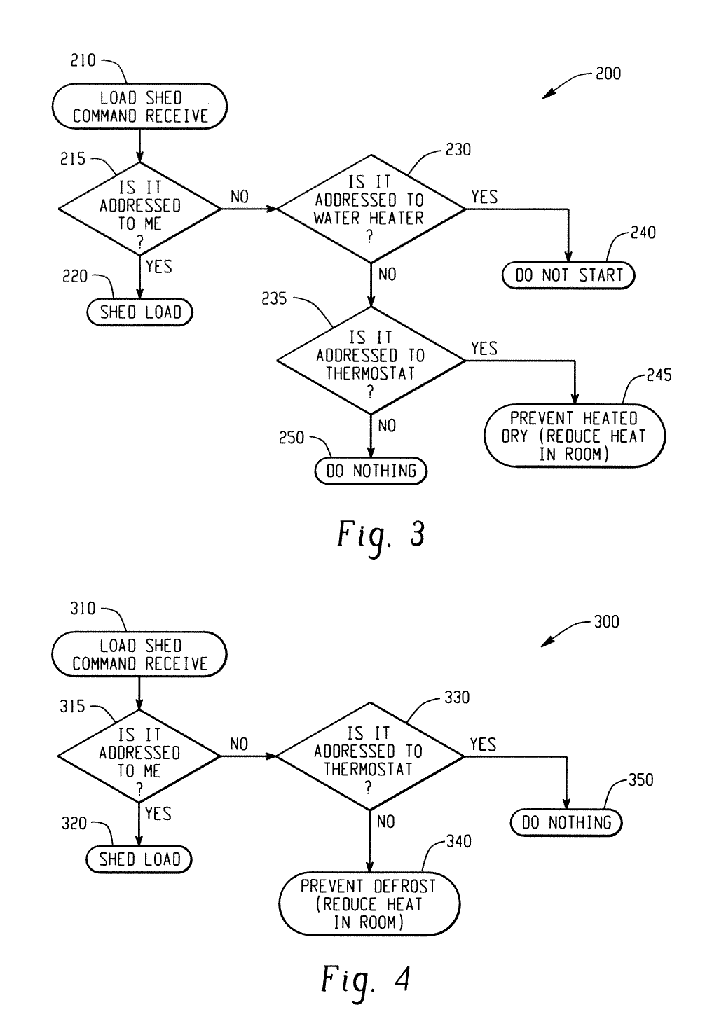

The present disclosure is an energy management system that may be used with an appliance, and/or a household of appliances, in order to reduce household electricity costs and also to reduce the load on generating plants during peak hours of electricity usage. The energy management system is applicable to, and can be used in conjunction with, any and all types of household appliance(s)/devices such as a dryer, a clothes washer (FIG. 2), a dishwasher (FIG. 3), an oven/range, a refrigerator (FIG. 4), microwave oven, hot water heater, HVAC system, plug outlet load, household lighting, etc.

In one embodiment, the energy management system may include a user interface, a time keeping mechanism, a mode selecting device, and a functional or operational association of one or more appliances to at least another appliance. The user interface may be any type of interface such as a touch screen, knobs, sliders, buttons, speech recognition, etc, to allow a user to input a schedule of on-peak times or schedules and off-peak times or schedules for each day of the week. The schedule of on-peak times and off-peak times for a household may typically be obtained from a generating plant or power utility that services the household. The schedule may be obtained from published tables made available to the public or other means such as billing statements. If the schedule of on-peak and off-peak times changes, the user may use the user interface to alter and update the schedule that was previously entered. The mode selecting device allows the user to select an energy management mode. The mode selecting device may be a single button such that the energy management mode is selected when the button is depressed. Alternatively, the mode selecting device may also be two separate buttons, a switch, a touch panel, or any other type of device that allows for selection of the energy management mode. Although the control panel, the user interface, the time keeping mechanism, the mode selecting device, and the association table (not illustrated) can be five separate elements, each of these elements, or any combination thereof, may alternatively be incorporated into a single interface or display to provide for ease of use.

The terms on-peak and off-peak, as used herein are meant to encompass time periods that an energy supplier has designated as referring to periods of high energy demand or cost and periods of low energy demand or cost, respectively. It may be that in some situations, multiple levels are designated by the energy supplier and thus on-peak is meant to refer to those periods where the energy demand or cost is greater than some other period, with the other period being referred to as off-peak. In any given situation, on-peak may not be the highest level of cost or energy demand and off-peak may not be the lowest level of cost or energy demand.

A home energy management system can also include a time keeping mechanism (not shown) that provides information to the appliance and user regarding the current time of the day. In one embodiment, the time keeping mechanism also includes a calendar function to provide information regarding the day of the week and the current date. The current time and date may be input or adjusted by the user via controls on the time keeping mechanism. To be described in more detail hereinafter, the system can also provide an association mechanism or table that provides information to the appliance and user regarding the operational associations of one or more appliances to all other appliances.

Utility companies are starting to develop sliding rate scales based upon time of use for power consumption. A home that can manage a response to a different rate schedule will have an advantage in the marketplace. A time of day (TOD) import to the appliances will allow the unit to run at times, on more occasions, and/or during more periods when utility rates are low or off-peak. The time of day input can be manually entered or automatically received by the appliances (an example of automatic updating would be using a radio wave or radio clock to sync to an atomic clock signal). The time of day feature, off-peak manager, or appliance associations can effectively save the consumer money by running the appliances according to a pre-determined schedule or associated functioning, i.e. predominantly, when the rates are lower or when one appliance is shedding load. Prior art systems directed load shedding commands at individual or single appliances in isolation. As shown in FIG. 1, once a load shed command is received 10, the single appliance determines if the load shed is directed at the same single appliance 15. If the load shed is directed at the appliance, that same single appliance will shed load 20. If the load shed is not directed at the appliance, that same single appliance will take no action in response to the load shed command 50.

The present disclosure can utilize a series of algorithms in a home energy management system to compare the amount and/or cost of energy from a utility supplied to the home and can allow the appliances to be powered by the utility in a selected manner and to associate one appliance's functioning to at least another appliance's functioning. The functioning of an appliance can comprise its features/functions, duration and settings of same, time of day of operation, etc.

The energy management system controller is operatively coupled to the control panel and the mode selecting device in order to receive signals regarding the operation selected by the user via the control panel and the mode selected by the user via the mode selecting device. The controller can also be operatively coupled to the user interface, the time keeping mechanism and the association table, and preferably includes a memory for storing the schedule of on-peak and off-peak times input via the user interface, the current time and date, as well as the associated operational functions of one or more appliances to all other appliances. In one embodiment, the controller has a circuit, software, and/or firmware (hereafter collectively referred to as “firmware”) to determine a time and associated operational functions to initiate the selected operation based on the selected mode.

The present disclosure provides a system and method for coordinating a suite of demand response appliances that are capable of responding to incoming signals from utilities that calls for a “load shedding or load control” event. The home energy management system controller can also provide feedback to the user regarding the performance and the associations of the appliances through home usage data. The user will be able to monitor and/or modify the appliance responses and associations as well as get real time feedback as to the energy consumption of the appliances. For electrical devices, the controller is configured to characterize the power consumption of the appliances at any given point using appliance data from current transducers, shunts, meter pinging, or lookup tables.

Referring to FIGS. 2-4, the present disclosure provides a system and method of for controlling appliance loads so as to limit, and/or optimize the overall energy usage by the appliances in the system. In one embodiment, a method is provided for managing energy usage of a plurality of appliances. The method can comprise receiving a schedule of peak demand periods during which it is desirable to reduce or shed load. The method includes storing the schedule in a memory; determining a current time; and initiating a hierarchical order of appliance(s) operation and function during the scheduled load shedding or peak demand period.

In addition to the above, control of the total home energy consumption can also be applied to those home energy management systems that receive demand response (pricing and load control) events from a utility. The system can manage and associate the whole home consumption for each demand response event.

The system controller can communicate wirelessly with a smart meter or other ESI (Energy Services Interface), all networked appliances, and programmable load switches (a 120V or 240V outlet that contains line interrupt switch(es) that can be turned on or off by means of a wireless signal). The controller receives current power consumption information from each of these networked devices and thus can calculate and control the entire home's energy consumption as well as the breakdown by appliance/load.

Demand management can be performed by utilities in two key ways: controlling price, where certain times of the day or week have high prices to discourage contribution; and, direct control, where a load shed command is signaled to a group of homes. Several load management standards have commands for specific types of devices to shed load. The present disclosure, using the HEM, can look at the load shed commands and relate those commands from one appliance to other appliances and respond accordingly.

Referring now to FIG. 2, one exemplary flow chart implemented in the appliance controller of a clothes washer for responding to load shed commands is therein shown. As hereinbefore described, the central controller establishes a hierarchy for responding to peak demand signals from a utility. In accordance with that hierarchy, the central controller sends load shed commands directed to the appropriate appliance or appliances in the network. Though directed to one or more particular appliances the command is received by all of the appliances in the network. Each appliance controller determines what appliance or appliances the command is directed to and responds accordingly. In FIG. 2 the appliance controller for the clothes washer receives a load shed command 110. If the load shed command is directed to the clothes washer 115, then the clothes washer sheds load 120. If the load shed command is not directed to the clothes washer, then another related appliance is queried to determine if the load shed is addressed to the another appliance. In the example of FIG. 2, the appliances associated with the clothes washer are a water heater and clothes dryer. Queries are made to determine if the load shed command is addressed to either of these appliances 130, 135. If the load shed command is addressed to a water heater 130, then operation of hot or warm cycles for the clothes washer is suspended 140. If the load shed command is addressed to the clothes dryer 135, then the clothes washer will extend the spin cycle 145 to extract additional moisture. If the load shed command is not addressed to either the water heater or the clothes dryer, then the clothes washer will not do anything further to shed load 150.

Referring to FIG. 3, similarly another exemplary flow chart is therein shown for the appliance controller of a dishwasher for responding to load shed commands. The appliances associated with the dishwasher are a water heater and a thermostat for a HVAC system. The exemplary flow chart of energy management 200 can receive a load shed command 210. If the load shed command from the central controller is addressed to the dishwasher 215, then the dishwasher sheds load 220. If the load shed command is not addressed to the dishwasher, then the water heater and thermostat are queried to determine if the load shed command is addressed to either of these appliances 230, 235. If the load shed command is addressed to a water heater 230, then the dishwasher will not start 240. Alternatively the dishwasher could delay starting if the water heater is shedding load in order to save the hot water in the water heater tank for cooking and bathing. If the load shed command is addressed to the thermostat 235, then the dishwasher will prevent or skip a heated dry cycle 245 in order to reduce the heat in a room. If the load shed is not addressed to either the water heater or the thermostat, then the dishwasher will not do anything further to shed load 250.

Referring to FIG. 4, similarly another exemplary flow chart is therein shown for the appliance controller of a refrigerator for responding to load shed commands. The associated appliance for the refrigerator is the HVAC thermostat. The exemplary flow chart of energy management 300 can receive a load shed command 310. If the load shed command is addressed to the refrigerator 315, then the refrigerator sheds load 320. If the load shed command is not addressed to the refrigerator, the thermostat is queried to determine if the load shed is addressed to the thermostat 330. If the load shed is addressed to the thermostat 330, then the refrigerator will prohibit or suspend operation in a defrost cycle 340 in order to reduce heat in a room. If the load shed is not addressed to the thermostat, then the refrigerator will not do anything further to shed load 350.

In the above described illustrative embodiments the load shed commands are issued by the central controller. However, the particular appliance load shed commands could be issued by the utility or demand server and communicated directly to the appliance controllers whether or not the particular network of appliances has a central controller.

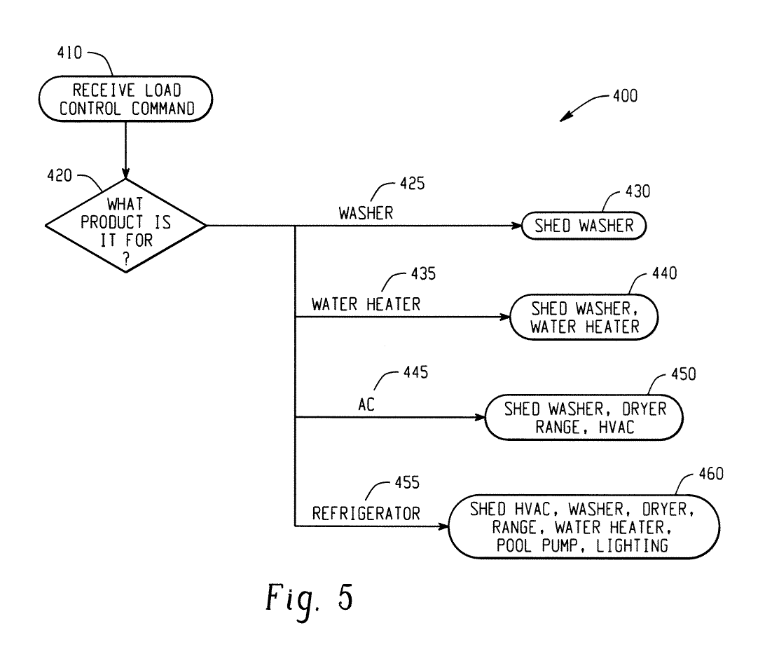

The HEM or central controller, in response to certain load shed commands from the utility, to alter or suspend specific appliance loads, can allow other units/appliances to respond to the load shed commands not directed to them. For example if air conditioning is offset by 5 degrees, the refrigerator could adjust its internal thermostats either proportionately or by a fixed amount to reduce the waste heat being dumped into the room. Either the HEM or a smart appliance could look at commands to other devices and respond to those commands with an associated response. FIG. 5 shows several exemplary load shed commands directed at specific appliances and a related load shed command(s) for other appliances. The HEM system 400 can receive a load shed control command 410 and then determine what appliance or product the load shed is directed toward 420. If the washer is the directed appliance 425, then the washer sheds load 430. If the water heater is the directed appliance 435, then the washer and water heater shed load 440. If the air conditioner is the directed appliance 445, then the washer, dryer, range, and air conditioner shed load 450. If the refrigerator is the directed appliance 455, then the air conditioner, washer, dryer, range, water heater, pool pump, and lighting shed load 460.

Technical advantages allow selective mapping beyond the capability of the isolated operational modifications of a single appliance (i.e. a specifically targeted appliance). For example, load shedding for a clothes washer can be in response to ‘another appliance’ or ‘water heater’ or to allow for devices not specifically targeted. Additional variants can comprise bulk storage tanks for laundry, dishwasher, or dry cleaning appliances could shed circulation or filtering options on a load shed to pool pumps. Alternatively, an appliance or home energy monitor could be set to shed all loads, or portions of loads, whenever anything is sent a load shed command in order to maximize the economic or environmental benefits.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

1. A household energy management system and method for managing multiple appliances, comprising:
a controller for managing power consumption of multiple appliances within a household;
a communication network connecting the controller to one or more of the utility meter and/or the demand server;
the controller maintains in a memory the managing of power consumption of the multiple appliances based on an association of one appliance to at least another appliance; and,
the controller instructs one or more appliances to shed load demand, and wherein the at least another appliance sheds load or increases load based on the associated load shed of the one appliance.

2. The household energy management system and method of claim 1, further comprising:
an appliance user interface through which a user can enter a parameter of energy usage wherein the parameter comprises an association of the one appliance to the at least another appliance;

3. The household energy management system and method of claim 2, wherein the appliance user interface associated with each of the one or more appliances allows a user to associate one or more functions of the one appliance to the one or more functions of the at least another appliance.

4. The household energy management system and method of claim 3, wherein the one or more appliances includes one or more of household lighting, a refrigerator, a clothes washer, a dryer, an oven/range, a microwave oven, a dishwasher, an HVAC system, a hot water heater, and a plug outlet load

5. The household energy management system and method of claim 1, wherein the associations are preprogrammed into the one or more appliances.

6-8. (canceled)

9. An appliance control method, comprising:
a controller for controlling the operation of multiple appliances in a normal mode and a modified mode;
the controller maintaining an association of one appliance to at least another appliance including establishing a hierarchy of an order and manner for the controller to disable, suspend, reduce, or increase one or more functions of the at least another appliance upon a reduction of load of the one appliance; and,
wherein reducing the load of the one appliance in the modified mode initiates the load shedding or load increase of the at least another appliance.

10. The appliance control method according to claim 9, wherein the controller instructs one or more appliances to shed load demand, and wherein the at least another appliance sheds load or increases load based on the load shed of one or more appliances.

11. The appliance control method according to claim 10, further comprising:
an appliance user interface associated with each of the one or more appliances that allows a user to associate one or more functions of the one or more appliances to the one or more functions of another appliance.

12. The appliance control method according to claim 9, wherein the one or more appliances includes one or more of household lighting, a refrigerator, a clothes washer, a dryer, an oven/range, a microwave oven, a dishwasher, an HVAC system, a hot water heater, and a plug load.(see 3)

13. The appliance control method according to claim 10, wherein the associations are preprogrammed into the one or more appliances.

14. A household energy management system and method for managing multiple appliances, comprising:
a controller for managing power consumption of Multiple appliances within a household;
a communication network connecting the controller to one or more of the utility meter and/or the demand server;
the controller maintaining in a memory an association of one appliance to at least another appliance including establishing a hierarchy of an order and manner for the controller to disable, suspend, reduce, or increase one or more functions of at least another appliance upon a reduction of load of one appliance one appliance to at least another appliance; and,
the controller instructs one or more appliances to shed load demand, and wherein the at least another appliance sheds load or increases load based on the associated load shed of the one appliance.

15. The household energy management system and method of claim 14, further comprising:
a user interface through which a user can enter a parameter of energy usage wherein the parameter comprises an association of the one appliance to the at least another appliance.

16. The household energy management system and method of claim 15, further comprising:
an appliance user interface associated with each of the one or more appliances that allows a user to associate one or more functions of the one appliance to the one or more functions of the at least another appliance.

17. The household energy management system and method of claim 14, wherein the associations are preprogrammed into the multiple appliances.
